(19) United States
(12) Patent Application Publication
(10) Pub. No.: US 2017/0231207 A1
(43) Pub. Date: Aug. 17, 2017

(54) FISHING ACCESSORY FOR LURES

(71) Applicants: Ramiro Rubén TARAZONA SICILIA, Tarazona (ES); Sergio LONGÁS VACAS, Caspe (ES)

(72) Inventors: Ramiro Rubén TARAZONA SICILIA, Tarazona (ES); Sergio LONGÁS VACAS, Caspe (ES)

(21) Appl. No.: 15/042,971

(22) Filed: Feb. 12, 2016

(51) Int. Cl. A01K 85/02; A01K 97/00

(52) U.S. Cl. CPC A01K 85/02; A01K 97/00

(57) ABSTRACT

A fishing accessory for several different lures for coupling to a fishing device that can be reeled or trolled in a certain direction in order to catch fish. The fishing accessory includes a first lure, in the form of a main fish, and at least two second lures, smaller in size than the first lure and accompanied by flexible transparent elements attached to a rigid head forming part of a supporting structure of the first lure in the shape of a V, facing either towards a surface or bottom of a fishing area.

### TECHNICAL FIELD

The present invention relates to a fishing accessory for several lures, coupled to a fishing device.

### BACKGROUND OF THE INVENTION

A fishing accessory according to embodiments of the invention is for catching fresh or salt water predators by pulling a lure through the water, either by casting and reeling or by the so-called trolling method (i.e. drawing it behind a moving boat) in order to attract the attention of a target fish so that the fish will be deceived by the lure and will strike it, biting a fishing hook as a result.

With regard to the aforementioned technique, fishing accessories for different types of lures are known in the prior art, both lures simulating fish of a suitable type to be captured by the target fish and lures with special features for attracting the attention of the target fish on being trolled or reeled in the water such as, in particular, jigheads, crankbaits, jerkbaits, vibrating blades, waving blades, or spinnerbaits.

The disadvantage of the fishing accessories for several lures known in the prior art is that they are joined together by a metal structure, making the resulting unit heavy, bulky, difficult to handle, and unnatural due to the numerous wires making it up.

Embodiments of this invention overcome this disadvantage.

### SUMMARY

Embodiments of the invention include a fishing accessory for coupling to a fishing device that can be reeled or trolled in a certain direction in order to catch fish, equipped with a first lure in the form of a main fish, and having at least two second lures, smaller in size than the first lure. A supporting structure for the lures consists, firstly, of a rigid head configured to simulate the head of a main fish and equipped with means of coupling to the fishing device and means of hooking on the body of the main fish and a fishing hook and, secondly, of flexible, transparent supporting elements for the second lures emerging from the rigid head in the shape of a V, facing either towards a surface or a bottom of a fishing area.

Embodiments of the invention provide a new concept of a compact varied multi-function lure, easy to handle and with a very natural swimming motion due to the flexible transparent supporting elements of the second lures, while its most outstanding feature with regard to the prior art is its great advantage of imitating food that is “easy” for predator fish to capture, bringing out their killer instinct and encouraging them to strike.

The flexible transparent elements make the supports of the second lures less visible, while achieving a better response to speed variations, as they move towards and away from the first lure in accordance with its speed.

The flexible transparent elements are preferably made of fluorocarbon, although they may be made of any traditional fishing line, and they include end sections with means of coupling to the second lures.

The second lures may take the form of secondary fish of a smaller size than the main fish or they may have other configurations, particularly rotating metallic blades producing vibrations and flashes.

Embodiments of the invention may also comprise third elements producing vibrations and/or flashes, particularly configured as blades, props, buzzbaits, or spinnerbaits.

Other features and advantages of embodiments of the invention will become apparent from the detailed description provided below of embodiments illustrating its purpose in relation to the accompanying figures.

### BRIEF DESCRIPTION OF THE FIGURES

FIG. 1 is a side view of a fishing accessory according to an embodiment of the invention with a first lure in the form of a main fish and two second lures in the form of secondary fish.

FIG. 2 is a side view of a supporting structure for a fishing accessory according to an embodiment of the invention with a first lure in the form of a main fish and two second lures in the form of fish.

FIGS. 3 and 4 are similar views to FIG. 2, including additional elements.

FIG. 5 is a side view of a supporting structure for a fishing accessory according to an embodiment of the invention for a first lure and four second lures in the form of fish.

FIG. 6 is a similar view to FIG. 2, but with a different location and type of fishing hook (a treble hook).

FIGS. 7 and 8 are side views of a supporting structure for a fishing accessory according to embodiments of the invention for a first lure and two second lures in the form of fish and a third element in the form of a metallic blade producing vibrations and/or flashes.

FIG. 9 is a similar view to FIG. 2, except for a configuration of a fishing hook (which is articulated) and the means of hooking the main fish.

FIG. 11 is a side view of a supporting structure for a fishing accessory according to an embodiment of the invention for a first lure and two second lures in the form of a blade.

FIGS. 10, 12, and 13 are side views of a supporting structure for a fishing accessory according to embodiments of the invention for a first lure and two second lures in the form of fish and a third element producing vibrations and/or flashes with shapes other than those of fish (adapted to propbait, buzzbait, and spinnerbait).

### DETAILED DESCRIPTION

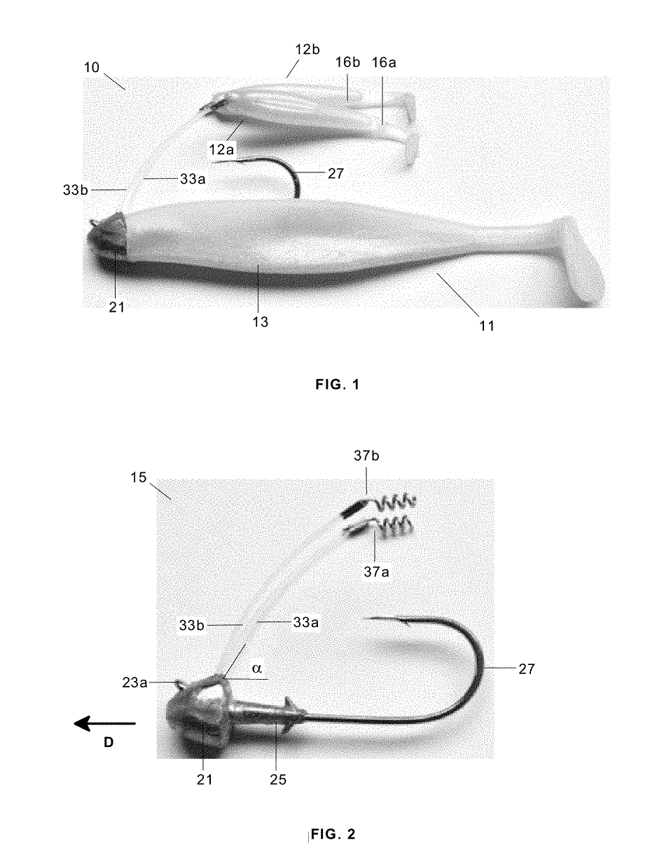

In the embodiments of the invention illustrated in FIGS. 1 and 2, a fishing accessory 10 comprises a first lure in the form of a main fish 11 and two second lures 12a,12b in the form of secondary fish 16a, 16b of a smaller size than the main fish 11, consisting of a supporting structure 15 and of a body 13 of the main fish 11 and the secondary fish 16a, 16b made of a plastic material, typically vinyl.

The supporting structure 15 is comprised of a rigid head 21 with a shape simulating the head of the main fish 11, some means of hooking 25 on its body 13, a fishing hook 27, and flexible transparent supporting elements 33a, 33b of the secondary fish 16a, 16b. The rigid head 21 in the embodiments shown in FIGS. 1 and 2 is made of a metallic material, although it could also be made of injected plastic with a weight on its underside to suitably weigh it down.

Comparing FIGS. 1 and 2, it can be seen that the fishing accessory 10 is configured with the end of the fishing hook 27 protruding from the body 13 of the main fish 11, although in other embodiments the end of the fish hook 27 could be concealed inside a fish.

As a means of coupling the fishing accessory 10 to a fishing device, the rigid head 21 includes an eye 23a for knotting the fishing line of the fishing device, arranged to facilitate the stability of the fishing accessory 10.

The flexible transparent supporting elements 33a, 33b of the secondary fish 16a, 16b are joined at their base to the rigid head 21 and arranged so that they emerge from the latter in the shape of a V (that is, one points towards a right side and one towards a left side with respect to a hypothetical vertical plane dividing the body 13 of the main fish 11 into two parts) facing towards a surface of the fishing area and, preferably, in the opposite direction to that of the trolling or reeling of the fishing accessory 10, illustrated by the arrow D in FIG. 2. In the embodiment of FIG. 2, an angle of emergence α of the flexible transparent supporting elements 33a, 33b with regard to the rigid head 21 must be between 10° and 120° and, preferably, between 50° and 70°. This configuration of the flexible transparent supporting elements 33a, 33b provides the fishing accessory 10 with greater stability and better hydrodynamic performance.

The embodiment shown in FIG. 2 represents two flexible transparent supporting elements 33a, 33b, although additional supporting elements could be added. Likewise, in FIG. 2, elements 33a, 33b are represented as emerging from the rigid head 21 in the shape of a V facing towards the surface. In other embodiments, elements 33a, 33b may also emerge facing a bottom of a fishing area, or be on a parallel plane to the main fish 11.

In the embodiments shown in FIGS. 1-13, the flexible transparent supporting elements 33a, 33b are made of fluorocarbon, making them practically invisible to a target fish and facilitating the functional nature of the fishing accessory 10.

The flexible transparent supporting elements 33a, 33b have end sections 37a, 37b configured with suitable means of coupling to the secondary fish 16a, 16b, consisting, for example, of connecting bushings and hooking “springs or spirals” shown in the Figures. In other embodiments, not shown in the Figures, a configuration of a means of coupling includes fishing hooks.

Combining two types of lures (the main fish 11 and the two secondary fish 16a, 16b) simulates a small shoal of fish, or a mother fish with her young, making the embodiments of the invention particularly attractive and thus extremely effective for an angler using it.

The lures to be used (preferably imitating fish) may be of any size, color, or shape. Commercially available soft baits produced by different manufacturers may be used, adapting the size of the rigid head 21 to the size of the main fish 11 covering the fishing hook to give it the most realistic appearance possible.

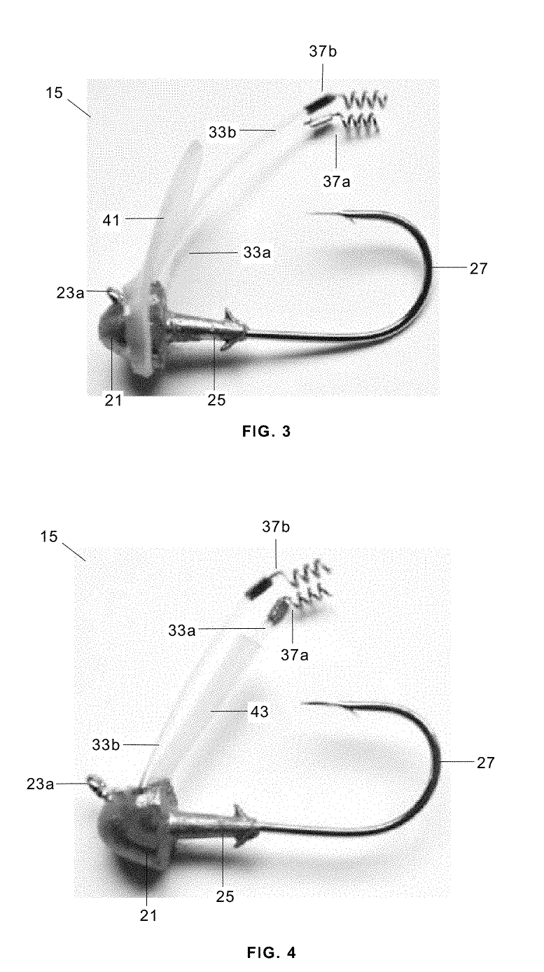

In the embodiments illustrated in FIGS. 3 and 4, the supporting structures 15 include additional elements with regard to the embodiment represented in FIG. 2. FIG. 3 includes a plastic lip 41 for transmitting vibrations and wiggling to the lure on water resistance when being reeled in, and FIG. 4 includes a set of semi-rigid fibres 43, commonly known as weed guards, preventing a fishing hook from hooking onto plants, trees, or any other submerged obstacle, and causing the lure to rebound on hitting obstacles, being on the same line as the fishing hook.

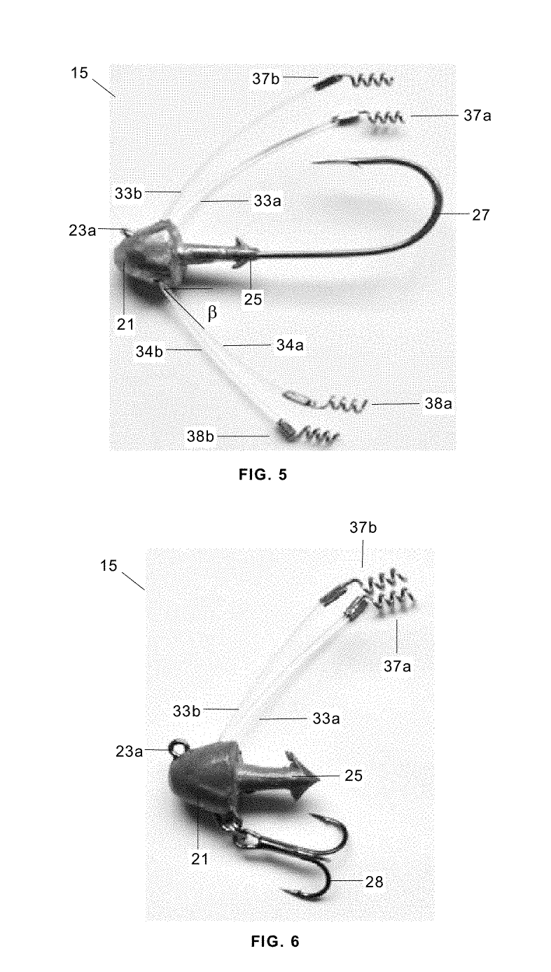

In the embodiment illustrated in FIG. 5, the supporting structure 15 includes additional flexible transparent supporting elements 34a, 34b with end sections 38a, 38b emerging from the rigid head 21 in the shape of a V, with an angle of emergence β between 10° and 120°, preferably between 50° and 70°, facing the bottom of the surface of the fishing area and in the opposite direction to the trolling or reeling direction of the fishing accessory 10. It thus consists of a supporting structure 15 for housing a main fish (such as the main fish 11 in FIG. 1) and two pairs of secondary fish (such as the secondary fish 16a, 16b in FIG. 1), with one pair swimming above the main fish 11 and another pair swimming under the main fish 11.

In the embodiment illustrated in FIG. 6, the supporting structure 15 differs from the embodiment represented in FIG. 2 with regard to the location of the fishing hook. In FIG. 6, a fishing hook 28 is arranged as hanging from the rigid head 21 so that it does not make contact with the main fish, which would be coupled to the supporting structure 15 by the hooking means 25. It may also be placed by inserting one of the ends of the fishing hook 28 in the belly of the main fish.

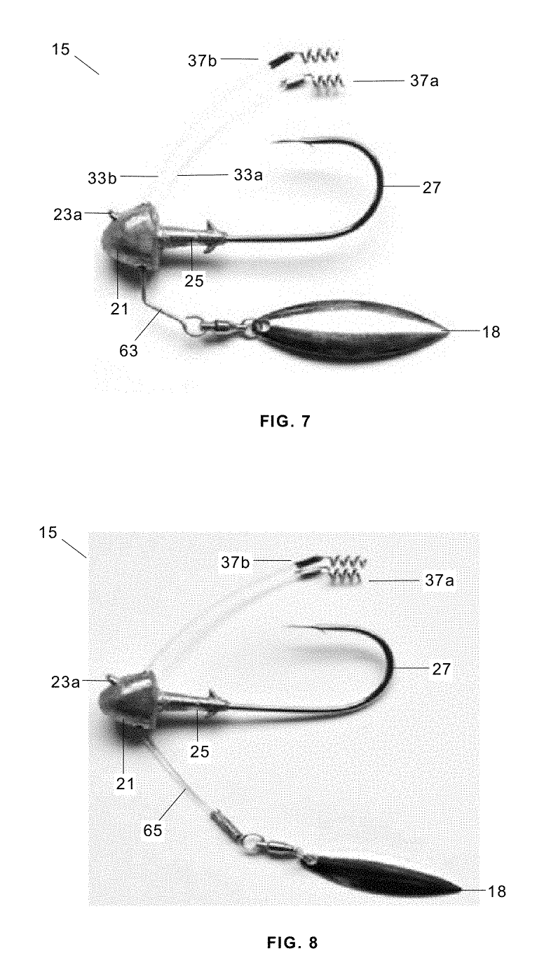

In the embodiments illustrated in FIGS. 7 and 8, the supporting structure 15 includes a part identical to that shown in FIG. 2 for housing the main fish and the secondary fish, and also includes a third element in the form of a blade 18 which would provide the unit with flashes and vibrations.

In FIG. 7, the third element is connected to the rigid head 21 by means of a metal rod 63 to which it is joined by some means enabling it to move freely with respect to the same.

In FIG. 8, the third element is connected to the rigid head 21 by means of a flexible rod 65, at least 50% of its length being made of a material such as fluorocarbon, to which it is joined by some means enabling it to move freely with respect to the same. As it is flexible and transparent, the joint will be less visible and will have a more natural movement, moving towards and away from the main lure according to its changes of speed.

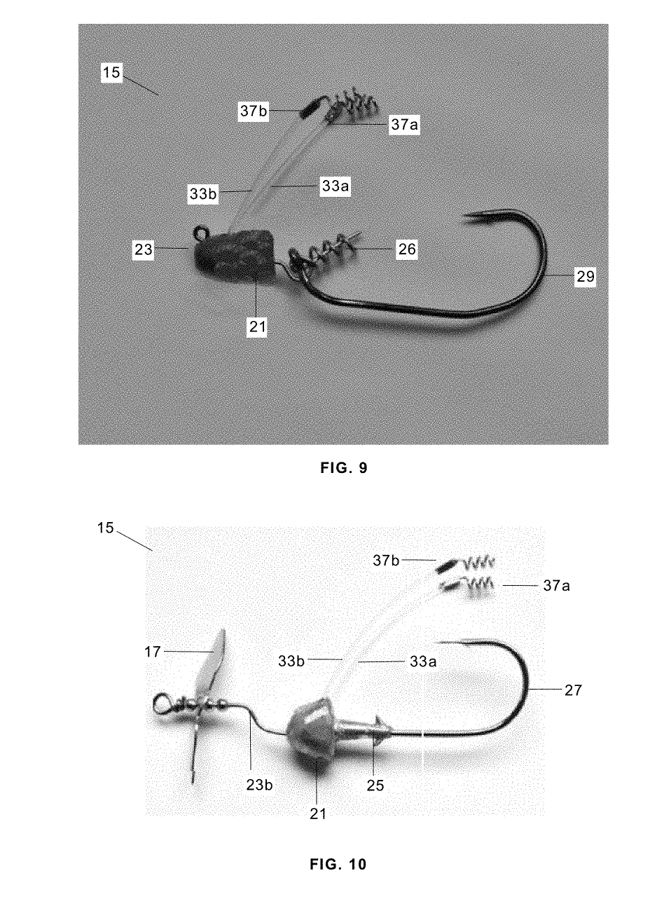

In the embodiment illustrated in FIG. 9, the supporting structure 15 differs from that shown in FIG. 2 in the arrangement of the hooking means 26 of the main fish and of the fishing hook 29. In particular, the latter is not rigidly joined to the rigid head 21 but articulated to the same so that it can move freely with respect to the rigid head 21 and is not in contact with the main fish. This configuration has the additional advantage of greater sideward mobility.

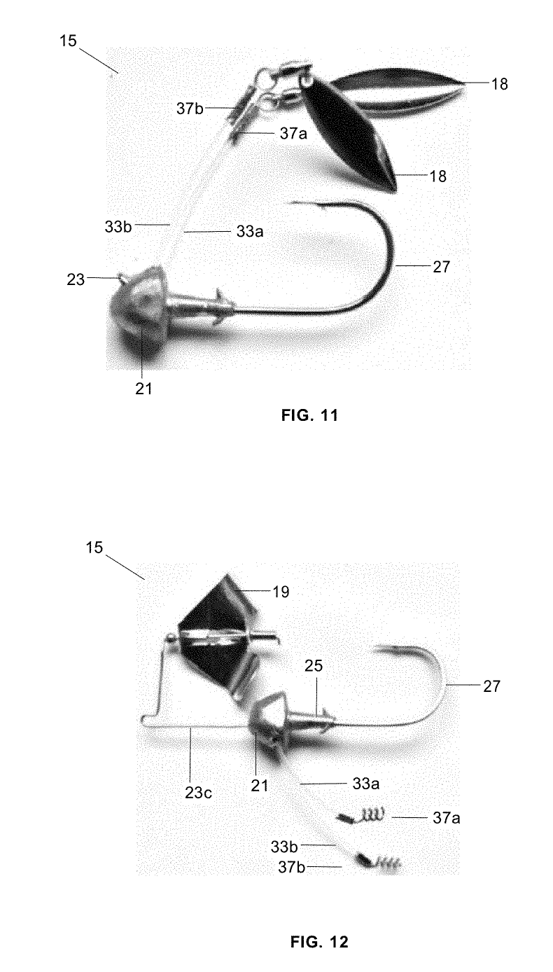

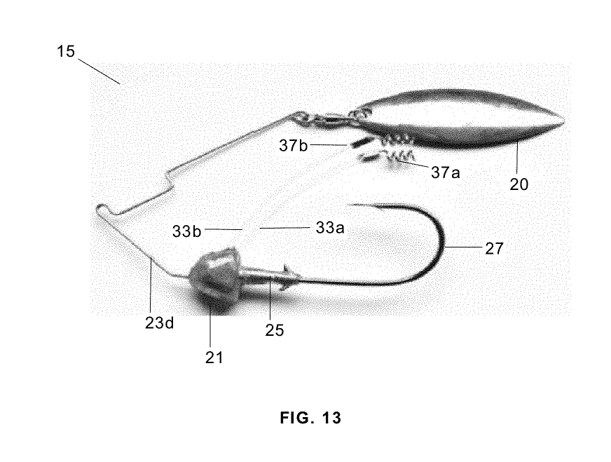

In the embodiment illustrated in FIG. 11, the supporting structure 15 is similar to that of FIG. 2, but the lures joined to the flexible transparent supporting elements 33a, 33b are not secondary fish but blades 18.

In the embodiments illustrated in FIGS. 10, 12, and 13, the supporting structure 15 comprises an identical part to that shown in FIG. 2 for housing the main fish and the secondary fish, and has some means of coupling 23b, 23c, 23d to the fishing device, and also includes a third element emitting vibrations and/or flashes, respectively configured as a prop 17, a buzzbait 19, and a spinnerbait 20.

Although several embodiments of the invention are described in detail above, it can be seen from the description that various combinations of elements, variations or improvements to the same can be made, resulting in additional embodiments of the invention.

1. A fishing accessory that can be coupled to a fishing device to be reeled or trolled in a certain direction in order to catch fish, comprising a first lure consisting of the body of a main fish and a supporting structure comprising a rigid head configured to simulate the head of the main fish and equipped with a coupling member to the fishing device, a hooking member on the body of the main fish and a fishing hook, including at least two second lures supported by two flexible transparent elements emerging from the rigid head in a shape of a V facing either towards a surface or a bottom of a fishing area.

2. A fishing accessory according to claim 1, whereby the two flexible transparent supporting elements emerge from the rigid head in an opposite direction to that of the reeling or trolling.

3. A fishing accessory according to claim 1, whereby an angle of emergence α of the flexible transparent supporting elements is between 10° and 120°.

4. A fishing accessory according to claim 1, whereby an angle of emergence α of the flexible transparent supporting elements is between 50° and 70°.

5. A fishing accessory according to claim 1, whereby the flexible transparent supporting elements are made of fluorocarbon or of any traditional fishing line.

6. A fishing accessory according to claim 1, whereby the flexible transparent supporting elements include end sections with a coupling member for coupling the second lures thereto.

7. A fishing accessory according to claim 6, whereby the coupling member is configured in the shape of a spiral.

8. A fishing accessory according to claim 6, whereby the means of coupling include a fishing hook.

9. A fishing accessory according to claim 1, whereby the supporting structure of the body of the main fish is configured with the fishing hook arranged after the hooking member on the body of the main fish.

10. A fishing accessory according to claim 9, whereby the at least two second lures are configured in the shape of a blade.

11. A fishing accessory according to claim 9, whereby the at least two second lures are configured as two secondary fish of a smaller size than the main fish.

12. A fishing accessory according to claim 10, which also includes a plastic lip arranged on the rigid head in a frontal position with regard to the supporting elements.

13. A fishing accessory according to claim 10, which also includes a series of semi-rigid fibres.

14. A fishing accessory according to claim 10, which also includes two additional second lures supported by two additional flexible transparent elements emerging from the rigid head in the shape of a V facing either towards a bottom or a surface of a fishing area.

15. A fishing accessory according to claim 14, whereby the two additional flexible transparent supporting elements emerge from the rigid head in an opposite direction to that of the reeling or trolling.

16. A fishing accessory according to claim 10, whereby an angle of emergence β of the additional flexible transparent supporting elements is between 10° and 120°.

17. A fishing accessory according to claim 14, whereby an angle of emergence β of the additional flexible transparent supporting elements is between 50° and 70°.

18. A fishing accessory according to claim 14, whereby the additional flexible transparent supporting elements are made of fluorocarbon or of any traditional fishing line.

19. A fishing accessory according to claim 10, whereby the coupling member includes a prop element joined to the rigid head.

20. A fishing accessory according to claim 10, whereby the coupling member includes a third element emitting vibrations and/or flashes configured as a buzzbait.

21. A fishing accessory according to claim 10, whereby the coupling member includes a third element emitting vibrations and/or flashes configured as a spinnerbait.

22. A fishing accessory according claim 10, which also includes a third element emitting vibrations and/or flashes without a fishing hook connected to the rigid head by means of a connecting element, being joined to the end thereof by some means enabling it to move freely.

23. A fishing accessory according to claim 22, whereby the third element emitting vibrations and/or flashes is configured in the form of a blade.

24. A fishing accessory according to claim 22, whereby the connecting element is a metal rod.

25. A fishing accessory according to claim 22, whereby the connecting element is a flexible rod made of a transparent material in at least 70% of its length.

26. A fishing accessory according to claim 1, whereby the supporting structure is configured with the fishing hook joined directly to the rigid head so that it hangs freely from the same.

27. A fishing accessory according to claim 1, whereby the supporting structure is configured with the fishing hook joined to the hooking member on the body of the main fish, which is joined to the rigid head so that it can move with regard to the same.
